(19) United States
(12) Patent Application Publication
(10) Pub. No.: US 2014/0183917 A1
(43) Pub. Date: Jul. 3, 2014

(54) VEHICLE SEAT THAT CAN BE MOVED FORWARDS IN ITS LONGITUDINAL GUIDE AND HAVING A FOLDING BACKREST

(71) Applicants: Burckhard Becker, Solingen (DE); Karl Utzinger, Weselberg (DE); Erik Weber, Bedesbach (DE)

(72) Inventors: Burckhard Becker, Solingen (DE); Karl Utzinger, Weselberg (DE); Erik Weber, Bedesbach (DE)

(73) Assignee: C. ROB. HAMMERSTEIN GmbH & Co. KG, Solingen (DE)

(21) Appl. No.: 14/130,905

(22) PCT Filed: Jul. 6, 2012
(86) PCT No.: PCT/EP2012/063208

§ 371 Date: Mar. 18, 2014

(30) Foreign Application Priority Data
Jul. 7, 2011 (DE) 10 2011 078 823.9

(51) Int. Cl. B60N 2/08

(52) U.S. Cl. CPC B60N 2/08
USPC 297/344.1; 29/428

(57) ABSTRACT

A vehicle seat has a memory unit for easy entry access. The unit includes a memory strip with teeth arranged one behind the other at a periodic interval in the longitudinal direction of the rails, a slider movably guided in the longitudinal direction of the rails on a guide element that is connected to the seat rail and a carriage with a housing which is guided on the memory strip in the longitudinal direction of the rails and in which a catch element is pivotably mounted. The periodic interval of the memory strip is equal to the difference between the periodic interval of the catch opening and the periodic interval of the locking teeth. The memory strip and carriage components are situated in a channel-shaped cavity defined by the rails.

The invention relates to a vehicle seat
with a base frame comprising at least one floor rail and a seat rail guided therein,
a lock for a longitudinal adjustment of these rails relative to each other, the lock comprising
   a) at least one ratchet tooth and
   b) a latching strip with latching openings disposed one behind the other in the longitudinal direction of the rails, which is connected to the floor rail,
with a memory device,
   a) comprising a memory strip comprising teeth that are disposed one behind the other in a periodic interval m in the longitudinal direction of the rails,
   b) comprising a triggering lever disposed so as to be pivotable on the seat rail and having a flank A,
   c) comprising a slider guided so as to be displaceable in the longitudinal direction of the rails on a guide member connected to the seat rail and
   d) comprising a carriage comprising a housing which is guided on the memory strip in the longitudinal direction of the rails and in which a latching member comprising a latching tooth cooperating with the teeth of the memory strip is pivotably mounted,
with a seat support which is connected to the base frame and on which a retaining cam is pivotably mounted,
with a seat rest
   a) connected to the seat support so as to be pivotable about a pivoting axis,
   b) comprising a trigger by means of which the folding of the seat rest forward about the pivoting axis can be triggered,
   c) comprising a stop cooperating with the retaining cam and retaining the seat rest in a forwardly folded position, and
   d) comprising a pin
with an unlocking Bowden cable whose core is connected at an upper end to the pin and at a lower end to the unlocking flap and whose jacket is disposed at an upper end on the seat support, and
with a comfort Bowden cable whose core is connected at an upper end to the retaining cam and at a lower end to the slider and whose jacket is connected at an upper end to the seat support and at a lower end to the slider.

In particular in the case of passenger cars that have only a single door on one side of a vehicle but comprise a second row of seats, it is known to fold the seat rest forward and then to displace the associated front set forward in its rail guide. This enables an easier entry. This is referred to as a comfort entry or easy entry function. For this purpose, a trigger is provided on the seat rest which cancels the block of the seat rest which is normally provided. Once the trigger is operated, the seat rest can be folded forward. The lock of the longitudinal adjustment mechanism is pulled free by this movement; the seat can be pushed forward in the rail guide. If this happens, the previously set position of the seat in the longitudinal adjustment mechanism is departed. Memory devices are known for being able to later relocate this position, when the seat is moved back again from the pushed-forward position. The invention relates to such memory devices. It aims to improve and simplify such memory devices.

With regard to the prior art, reference is made to DE 10 2006 009 265 A1 and EP 1 390 226 B1. Memory devices without a separate memory strip are known from DE 10 2009 010 226 A1 and DE 2004 001 388 U1.

The invention intends to dispose the components of the memory devices in the channel-shaped cavity, which the two rails delimit, to as large an extent as possible. Thus, the memory device is protected well. Only the necessary accesses for initiating actuations into the memory device are to be outside the rails. For this purpose, apertures, for example holes or the like, can be provided in the seat rail.

Based on this, the invention is based on the object of further developing the vehicle seat of the type mentioned in the introduction in such a way that the memory device enables a precise relocation, has a simpler structure and can be disposed well in the channel-shaped cavity.

This object is achieved by adding one, preferably more, of the following features to the features specified in the first paragraph:
the periodic interval m of the memory strip is equal to the distance of two immediately adjacent latching positions of the ratchet tooth and the latching strip;
the components memory strip and carriage are located in a channel-shaped cavity delimited by the rails,
the components triggering lever, slider and mounting member form a structural unit which can be preassembled and which is installed in the seat rail,
the teeth of the memory strip extend in an x-y-plane,
the retaining cam is biased by a first spring in the latching direction with the stop, whereby the core of the comfort Bowden cable is elastically biased,
the jacket of the unlocking Bowden cable extends over a first path in the normal state, and a second path in the actuated state of this unlocking Bowden cable, the two paths are different, the clear distance between the two ends of the jacket differs by at least 4 mm, preferably by at least 5 mm,
the lower end of the jacket of the unlocking Bowden cable is disposed on the triggering lever, and
the latching member executes a locking movement in the x-y-plane.

The smallest distance of two adjacent different latching positions of latching teeth in the latching strip is referred to as the increment t.

Other exemplary embodiments and features of the invention become apparent from the other claims as well as from the following description of exemplary embodiments of the invention, which are to be understood not to be limiting and which will be explained below with reference to the drawing. In the drawing:

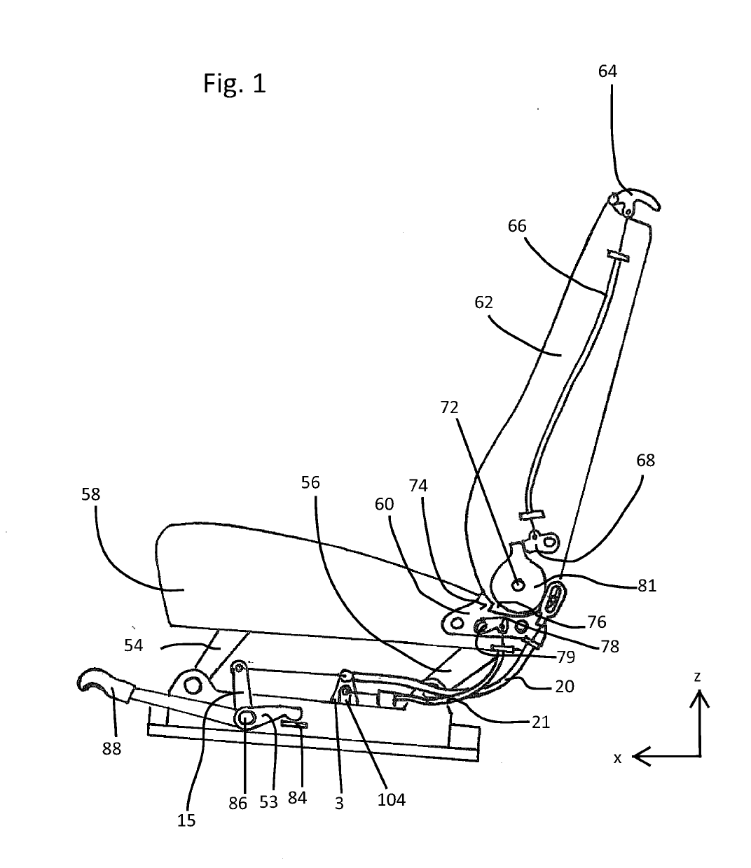

FIG. 1 shows a schematic side view of an entire front seat located in the normal position,

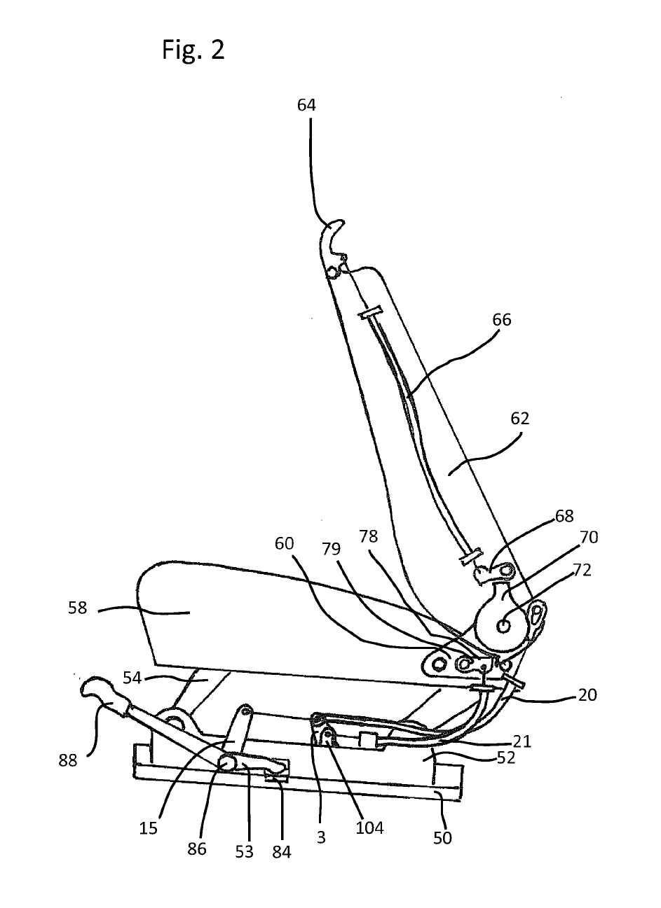

FIG. 2 shows an illustration as in FIG. 1, but the seat rest of the motor vehicle seat shown is now in the folded-forward position, the lock of the longitudinal adjustment mechanism is already released, the seat, however, is not yet moved forward in the longitudinal guide,

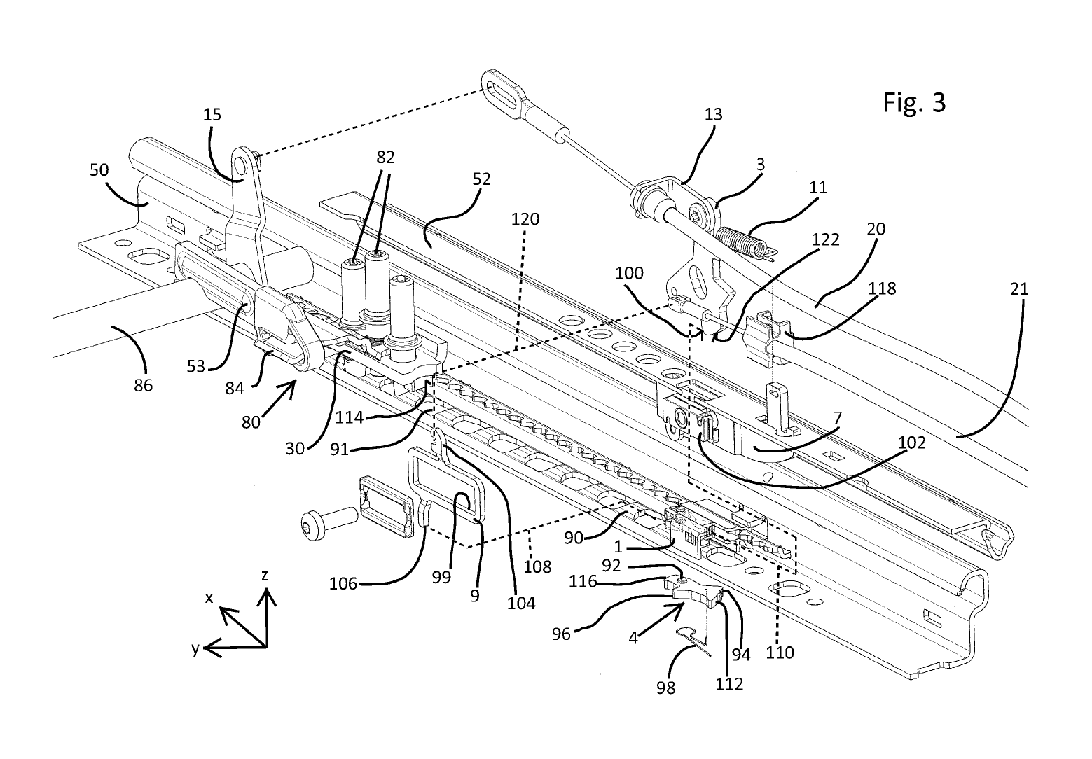

FIG. 3 shows a perspective assembly view of the parts of the seat according to the invention disposed in the region of the longitudinal guide,

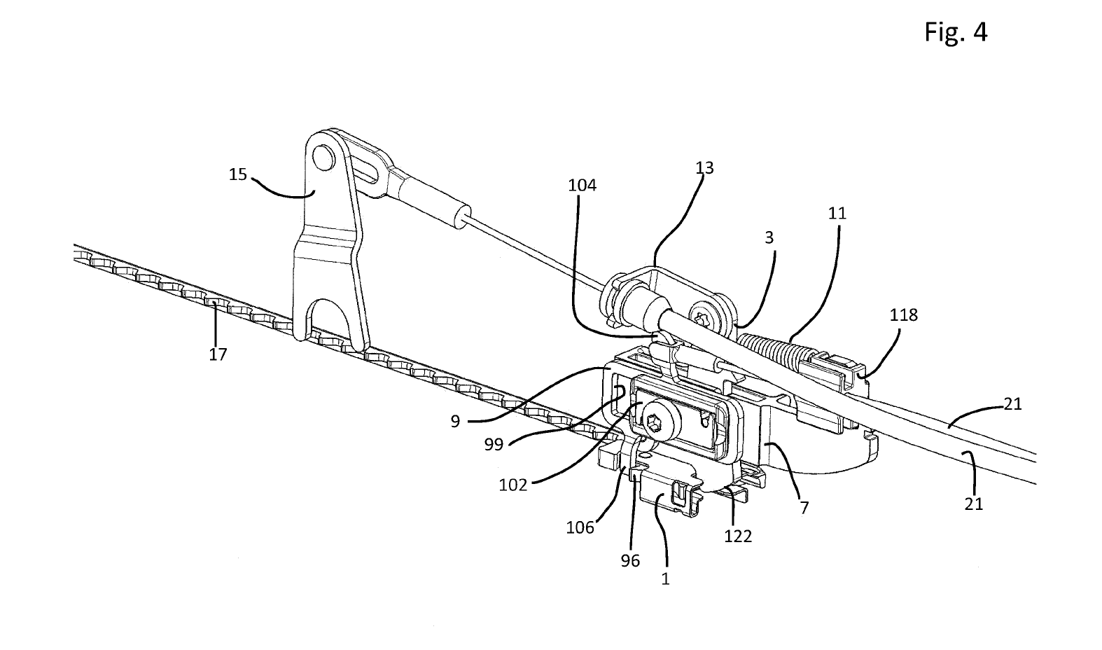

FIG. 4 shows a perspective view of a pre-assembled unit with further parts,

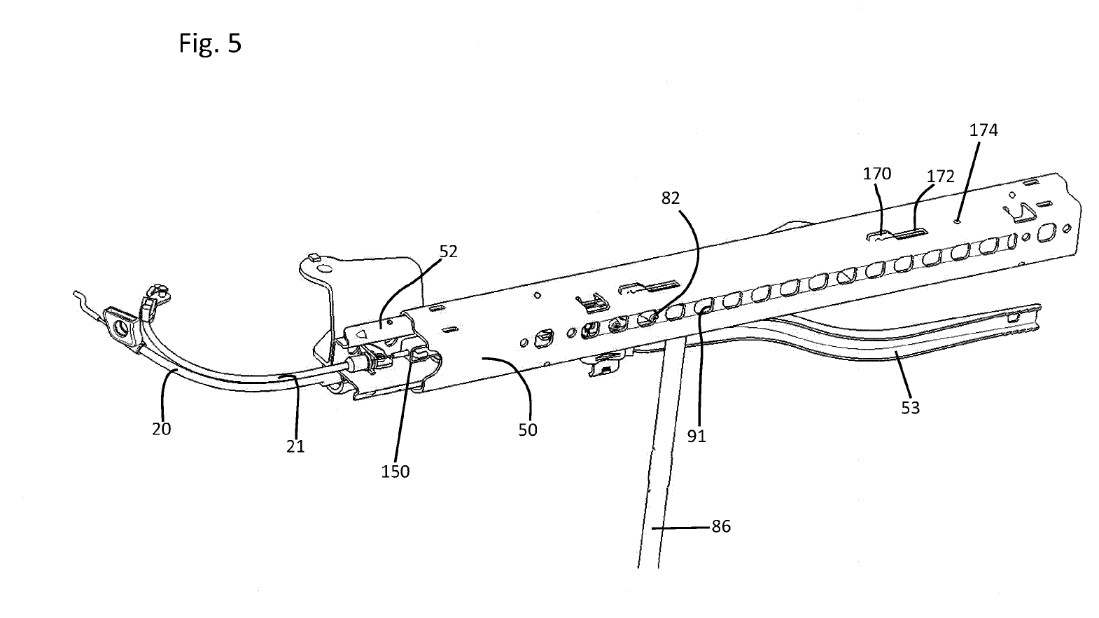

FIG. 5 shows a perspective view of a rail guide with a view from the rear, obliquely below, and for an improved embodiment,

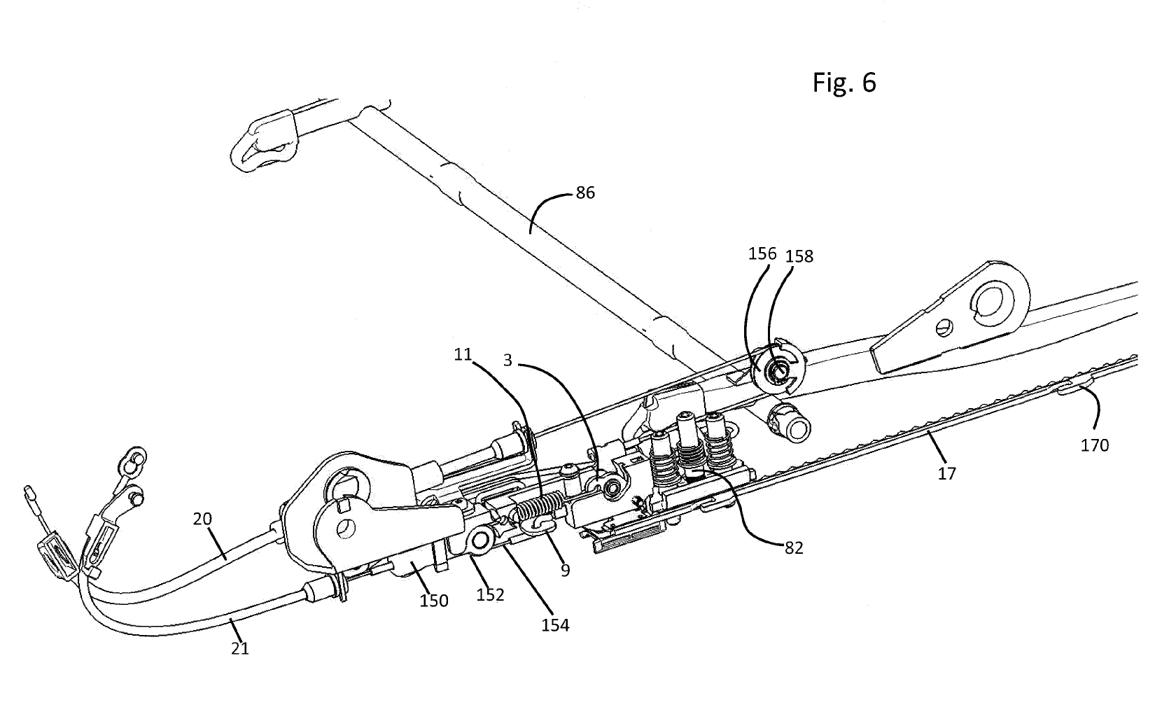

FIG. 6 shows a perspective view of the rail guide according to FIG. 5 with an oblique view from the rear, the outside and above, without, however, an illustration of the rails,

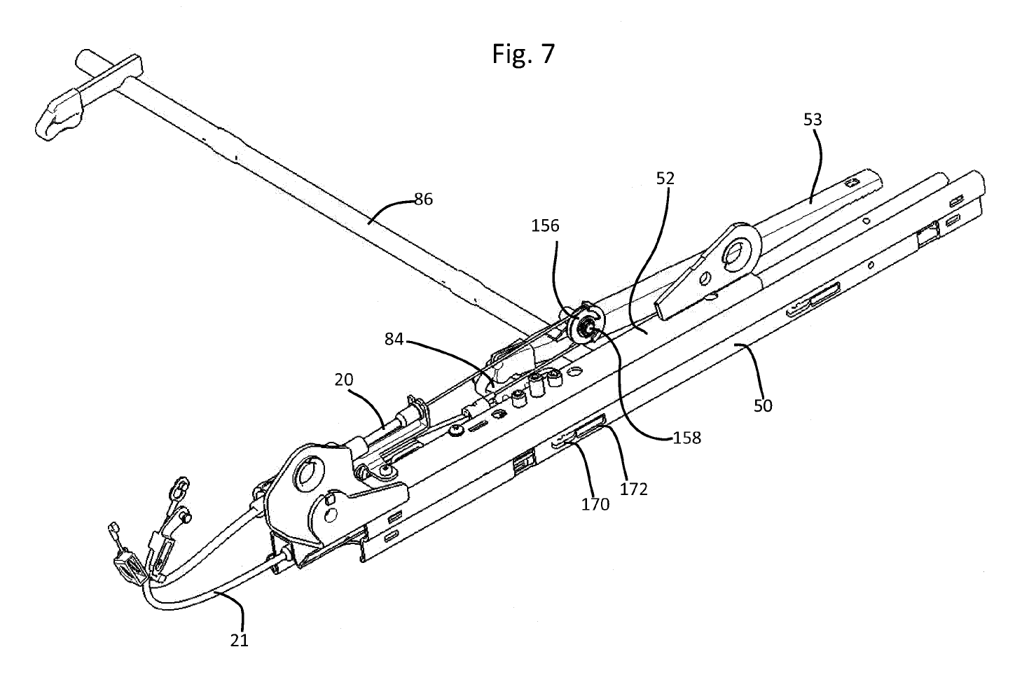

FIG. 7 shows a perspective view of the rail guide according to FIG. 5 with a view very similar to FIG. 6, but now with the rails shown,

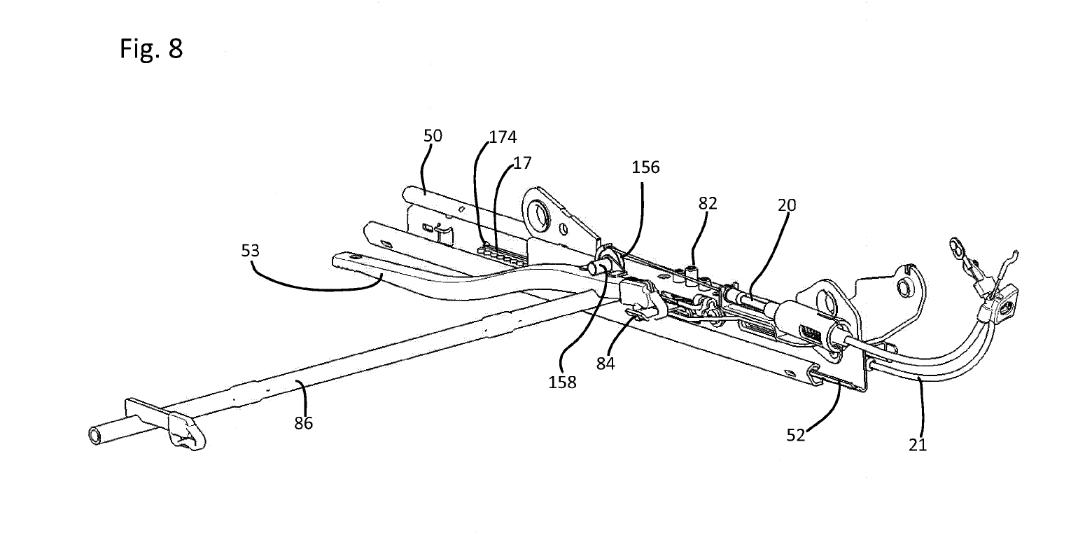

FIG. 8 shows a perspective view of the rail guide according to FIG. 5 with a view from the rear, the inside and slightly above the opposite rail guide,

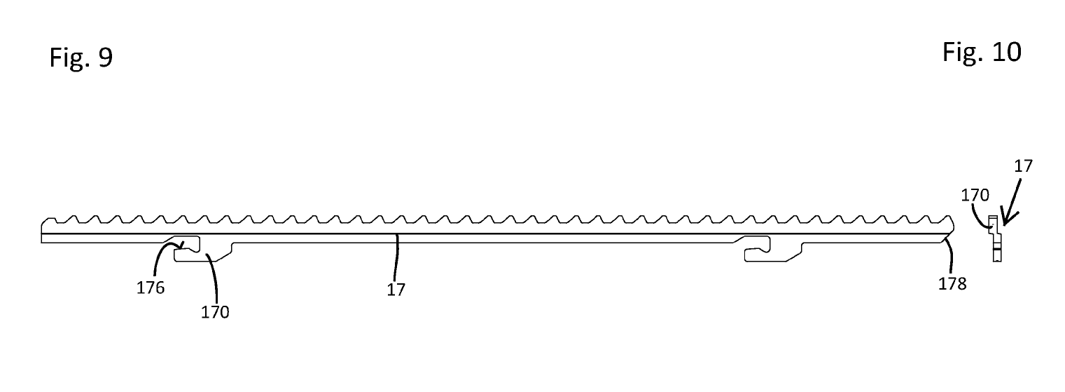

FIG. 9 shows a top view of a memory strip of the rail guide according to FIG. 5, and

FIG. 10 shows a section along the section line X-X in FIG. 9.

FIGS. 1 to 4 show a first exemplary embodiment. FIGS. 5 to 10 show an improved embodiment of this first exemplary embodiment, which has a total of three improvements. FIGS. 5 to 10 will be discussed only to the extent they differ from the first exemplary embodiment. Each of the three improvements is independent from the other improvements.

In the known manner, the vehicle seat comprises two pairs of rails, each with one floor rail 50 and a seat rail 52 guided therein so as to be displaceable in the longitudinal direction of the rails. The latter is hinged to a seat support 58 via a front arm 54 and a rear arm 56. On one side of the seat, a rear plate 60 is attached to the seat support 58. The seat support 58 is moreover hinged to a seat rest 62. A trigger 64 is disposed on the seat rest 62; it is connected, via a pulling cable 66, to a comfort cam 68 pivotably disposed on the frame of the seat rest 62. In FIG. 1, the trigger 64 is passive; the comfort cam 68 rests against a clamping flank of a retaining part 70 that is stationary on the seat rest. The seat rest 62 is pivotable about a pivot axis 72. Only a single pivot axis 72 is provided for the seat rest 62. In contrast to a technical solution in which the normal inclination adjustment of the seat rest 62 is carried out about a first pivot axis 72 and a folding forward of the seat rest 62 about a second pivot axis 72, only a single pivot axis 72 is provided in the seat according to the invention; both pivoting movements take place about this pivot axis 72. Alternatively, however, a solution can also be chosen in which the normal inclination adjustment of the seat rest 62 takes place about a pivot axis 72 different from that of the folding forward of the seat rest 62.

A perpendicular x-y-z coordinate system is used for the description. The x axis extends parallel to the longitudinal direction of the rails 50, 52. In the FIGS. 1 and 2, the y axis protrudes perpendicularly out from the surface of the drawing and is drawn in in FIG. 3.

In the illustration according to FIG. 2, the trigger 64 is actuated, the comfort cam 68 is pivoted out of its normal position and is now in a position in which it can no longer collide with the retaining part 70 when the seat rest 62 is pivoted forward. The folded-forward state is shown in FIG. 2.

A stop member 74 is provided on the seat rest 62; the former can also be formed on the retaining part 70, for example. In the normal position shown in FIG. 1, it is in contact with a counter stop 76 formed on the plate 60. A retaining cam 78 is pivotably disposed on the plate 60. It is positioned in such a way that it is normally located underneath the seat rest 62, particularly the stop member 74. It is biased in a counter-clockwise sense of rotation by a first spring 79. Thus, it rests against the retaining part 70. When the seat rest 62 is folded forward into the seat rest position shown in FIG. 2, it can optionally be pushed slightly downwards, if that is necessary; it remains in contact with the retaining part 70 and arrives in a position in which it is in front of the stop 74; this is shown in FIG. 2. It thus blocks the seat rest 62 being folded back. The first spring 79 is configured, for example, as a leg spring, grips around the axis of the retaining cam 78 and is supported, on the one hand, on the retaining cam 78 and, on the other hand, on the plate 60. Thus, the core of the comfort Bowden cable 21 is elastically biased.

The retaining cam 78 is connected via a comfort Bowden cable 21; for this purpose, the core thereof is connected to the retaining cam 78; the jacket of the Bowden cable is fixed on the seat support 58. Moreover, an unlocking Bowden cable 20 is provided. It has a core forming an elongated hole; the latter grips around a pin 81 which is disposed on the seat rest 62 at a distance from the pivot axis 72. The unlocking Bowden cable 20 moreover has a jacket which is fixed on the seat support 58, in this case specifically on the plate 60. If the seat rest 62 is folded from the normal position shown in FIG. 1 into the forwardly displaced position according to FIG. 2, tension 66 is exerted on the core of the unlocking Bowden cable 20, as is apparent from a comparison of the above-mentioned two FIGS. 1 and 2. A lock 80 of the longitudinal adjustment mechanism is thus actuated.

The longitudinal adjustment mechanism has a structure in accordance with the prior art. It has several, in this case three, ratchet teeth 82 that can be engaged independently from one another and disengaged jointly; they are constructionally identical. They are disposed one behind the other in a periodic interval r in the x direction. They are individually biased in the latching direction by a pin spring, which is not shown and known from the prior art. The latching direction corresponds to the negative z direction. Disengagement takes place via an unlocking flap 84, which, in the known manner, has a comb-like structure and is able to jointly lift the ratchet teeth 82. The unlocking flap 84 is actuated via a disengagement lever 53 pivotable about a cross bar 86. The pivoting movement is initiated via a driver lever 15 attached to the cross bar 86. By pulling the core of the unlocking Bowden cable 20, the lock 80 is canceled via the parts 15, 86, 53 and 84. A handle 88, via which the normally provided block of the lock 80 can also be canceled, is attached to the cross bar 86. Comparing FIGS. 1 and 2, it is apparent that the driver lever 15 is pivoted clockwise by the forwardly folded seat rest 62; the handle 88 is pivoted in the same direction; it is lifted. Thus, all the ratchet teeth 82 are pulled free.

The ratchet teeth 82 reach through holes, which are assigned to them, in a pin guide 30 attached to the seat rail 52. In the specific exemplary embodiment, they are substantially disposed in a channel-shaped cavity that the two rails 50, 52 delimit.

In the known manner, the floor rail 50 comprises a latching strip 90 in which latching openings 91 are disposed with a periodic spacing in the longitudinal direction of the rails 50, 52, into which the front ends of the ratchet teeth 82 can engage. The periodic interval, i.e. the distance of two latching openings 91 of the same kind in the latching strip 90, is p. The smallest distance of two adjacent different latching positions of latching teeth 82 in the latching strip 90 is referred to as the increment t. The following applies: t=r−p. The latching strip 90 is connected to the floor rail 50, preferably integrally therewith. Moreover, a memory strip 17 is connected to the floor rail 50. It extends parallel to the latching strip 90. It has a plurality of teeth formed similar to the teeth of a gearwheel; the memory strip 17 can be manufactured as a toothed rack with a normal toothing, e.g. an involute toothing. Other toothing methods are possible. The tips of the teeth are disposed at a distance in the longitudinal direction of the rails 50, 52; this distance defines a periodic interval m of the memory strip 17. This periodic interval m is selected so as to be equal to the increment t. The teeth protrude in the positive or negative y direction. The memory strip 17 has a length corresponding to the length of the latching strip 90 and differing therefrom by a maximum of 20%.

A carriage 1 is assigned to the memory strip 17; it is displaceably guided on the memory strip 17. For this purpose, an upper partial region of the carriage 1 reaches over the memory strip 17 from above, a lower partial region of the memory strip 17 from below. The memory strip 17 is grasped by the carriage 1 so completely that the latter cannot be pulled off transversely to the memory strip 17. Preferably, the carriage 1 comprises a plastic skidder that keeps the friction between the carriage 1 and the memory strip 17 low. In the carriage 1, a latching member 4 is pivotable about an axis 92 within a predefined angle range. The latching member 4 comprises a latching tooth 94 cooperating with the memory strip 17. It is configured so as to be able to engage between two teeth of the memory strip 17. This takes place when the memory is set. Normally, in the state shown in FIG. 1, this is not the case. Then, the latching member 4 is in a pivoting position, in which the tooth 94 is free of the memory strip 17.

The latching member 4 moreover has a lug 96 that is located outside the carriage 1. For this purpose, the carriage 1 comprises a recess that causes the lug 96 to be freely accessible.

A second spring 98 is accommodated in the carriage 1. It is disposed between the latching member 4 and the carriage 1. It elastically biases the latching member 4 into a position in which the tooth 96 is not in engagement with the memory strip 17. The action of the second spring 98 is supported by pressure on the lug 96 and pivots the latching member 4 into an engaging position.

A mounting member 7 is disposed in the aforementioned channel-shaped cavity on the seat rail 52. It comprises an arm which protrudes through a passage in the seat rail 52; see FIG. 3. A triggering lever 3 is pivotably mounted in the mounting member 7. The triggering lever 3 is pulled into a final position in the negative x direction by a main spring 11. The main spring 11 is disposed between an arm of the mounting member 7 and the triggering lever 3 and configured as a tension spring. The triggering lever 3 is a two-armed lever. An angle 13 is attached to its one upper lever arm; the jacket of the unlocking Bowden cable 20 is attached thereto. When the unlocking Bowden cable 20 is actuated by folding forward the seat rest 62, and as described above, not only is the driver lever 15 pivoted and thus the lock 80 pulled free, but rather, the triggering lever 3 is also pivoted. Thus, the unlocking Bowden cable 20 has a dual function. It causes the unlocking of the longitudinal adjustment mechanism and it causes a pivoting of the triggering lever 3. When the unlocking Bowden cable 20 is actuated, the distance between the two ends of the jacket measured along the line of sight changes, and does so preferably by at least 2% of the jacket length. In order to be able to realize both functions, at least one stop for the function primarily taking place is necessary. If the pivoting of the driver lever 15 is provided as the primary function, then it is first pivoted up to a stop position, then, the triggering lever 3 is pivoted. If the pivoting of the triggering lever 3 is alternatively chosen as the primary function, a stop has to be assigned to the triggering lever 3 and the movement of the driver lever 15 takes place once the stop is reached. It is preferred that the pivoting of the triggering lever 3 is used as the primary function. It is opportune to provide a stop, which is assigned to the pivoted position, for each of both movements. The primary function and the secondary function are obtained by choosing the respective springs, i.e. the spring 11 and a spring which is not shown and which biases the unlocking flap 84 and/or the cross bar 86.

On its other arm, the triggering lever 3 has a flank A 100. The triggering lever 3 reaches through a hole of the seat rail 52; see FIGS. 1 and 2. Over more than 50%, the triggering lever 3 is located in the channel-shaped cavity. A guide member 102 is disposed on the body of the mounting member 7. It is located in the channel-shaped cavity. It is grasped by a slider 9, which is guided so as to be displaceable in the longitudinal direction of the rails 50, 52 on a guide member 102. In this longitudinal direction, the guide member 102 has a length which is shorter, in particular by 6 to 8 mm, preferably 4 to 10 mm shorter, than the corresponding inner dimension of a window 99 of the slider 9. In order to reduce the friction between the guide member 102 and the window 99 of the slider 9, rollers are disposed at the top and the bottom of the guide member 102 which are in contact with the flanks of the window 99 that extend in the x direction and reduce the friction. The slider 9 is biased in its basic position by the first spring 79.

An actuating arm 104 protrudes upwards on the slider 9. The actuating arm 104 reaches through the hole of the seat rail 52; see FIGS. 1 and 2. The end of the core of the comfort Bowden cable 21 on the side of the rails acts on the actuating arm 104. Reference is made to the dashed line 120.

An actuating lug 106 protrudes downwards on the slider 9. As is illustrated by the dashed line 108, this comes into contact with the lug 96. Another dashed line 110 shows that the latching member 4, or to be exact a flank B 112 of the latching member 4, comes into contact with the flank A 100.

A contour C 114, which in the exemplary embodiment shown is configured to be concave, is located on the pin guide 30. It cooperates with a contact surface 116 of the latching member 4. In the specific exemplary embodiment, this contact surface 116 is centrical to the axis 92. The contour C 114, when in contact with the contact surface 116, is also centrical to this axis 92. On the whole, the contour C 114 and the contact surface 116 are configured in such a way that even an oblique contact, i.e. a contact that deviates by a few angular degrees from the longitudinal direction of the rails 50, 52, does not result in the latching tooth 94 being pivoted free from a latching position due to the contact or a corresponding impulse. In other words, the contact is to take place in such a way that the primary direction of the force, if possible, extends through the axis 92, or is in any case close to this axis 92. Due to the above-described concave configuration of the contour C 114, an important requirement is met for this type of contact.

On the bottom, the jacket of the comfort Bowden cable 21 is fixed in a connecting member 118; the latter is retained on the above-mentioned arm of the mounting member 7. The connecting member 118 for the end of the jacket of the comfort Bowden cable 21 on the side of the rail is secured by the spring end of the spring 11.

Since the memory strip 17 is located below the pin guide 30 in the embodiment shown, the contour C 114 is formed on a separate component that is located below the pin guide 30 and firmly connected thereto. The contour C 114 is located below the pin guide 30 at the same distance as the memory strip 17.

The basic position is described in the following: The lock 80 is in engagement, at least two ratchet teeth 82 are plunged into latching openings 91 of the latching strip 90. The latching element 4 is located in the immediate vicinity of the contour C 114; the distance is, for example, 0.1 to 0.2 mm. The triggering lever 3 is pulled backwards, in the direction of the seat rest 62, by the main spring 11. The unlocking Bowden cable 20 is relaxed. At the bottom, the comfort Bowden cable 21 is at its greatest elongation. The retaining cam 78 is open; it is not required. The seat rest 62 is locked by the comfort cam 68 and the rest against the counter stop 76. The window 99 of the slider 9 is free on the left-hand side; the left is the x direction. In other words, the guide member 102 is located at the rear end of the window 99. The actuating lug 106 of the slider 9 is in contact with the lug 96 of the latching member 4. The flank A 100 of the triggering lever 3 is in contact with the flank B 112. Due to the action of the spring 11 on the triggering lever 3, the flank A 100 reaches in front of the flank B 112 and pushes the flank B 112 outwards; thus, the latching member 4 is unlocked and has no contact with the memory strip 17.

A normal actuation of the longitudinal adjustment mechanism proceeds as follows: When the unlocking flap 84 is actuated via the handle 88, all of the ratchet teeth 82 are lifted. The seat rail 52 can now be displaced relative to the floor rail 50; a displacement in the longitudinal direction of the rails is carried out. The easy entry mechanism remains in its basic position. During adjustment, the carriage 1 is also pulled forward (towards the left in the drawing) via the flank A 100 when a forward displacement takes place. When the seat rail 52 is displaced towards the rear, the carriage 1 is pushed back via the contour C 114, which is in contact with the latching member 4. In the case of a normal adjustment of the rails relative to one another the carriage 1 is coupled to the pin guide 30 and thus moves together with it.

The spring 11 has priority over the second spring 98 biasing the latching member 4.

In the following, a displacement of the seat in a forward direction, starting from the normal position, is described: By folding the seat rest 62 forward, the unlocking Bowden cable 20 is tightened and pulls the ratchet teeth 82 free via the driver lever 15 and the unlocking flap 84. In addition, and preferably before, the triggering lever 3 is actuated and the flank A 100 goes up. When the flank A 100 is lifted, the leg spring biasing the latching member 4 is able to pivot the latching member 4 in the carriage 1; thus, the latching tooth 94 comes into engagement with the memory strip 17. Thus, the carriage 1 is uncoupled from the pin guide 30 and is associated with the memory strip 17 by positive fit. The positive fit is transverse in the direction of the longitudinal adjustment.

When the seat rest 62 is folded forward into the position pivoted in FIG. 2, the retaining cam 78 pivots upwards; it comes in front of the stop 74. The comfort Bowden cable 21 is retracted thereby; it goes into the relaxed position. Thus, it is no longer pulled. The slider 9 moves towards the rear; it comes into contact with the left front side of the window 99 of the slider 9. Due to the interaction of the retaining cam 78 and the stop 74, the seat rest 62 is blocked from folding back; it remains in the position shown in FIG. 2. The seat rest 62 first has to be folded forward to an extent where the retaining cam 78 is pivoted in front of the stop 74; it is only then that the seat can be pushed forward in the longitudinal adjustment mechanism via the folded-forward seat rest 62, which in this respect forms an actuating arm. The force that a user has to exert in order to fold the seat rest 62 forward is significantly smaller than the force for displacing the seat in the longitudinal guide; the difference is at least a factor of two.

If the seat is now pushed back again via the blocked seat rest 62, that is, the seat rails 52 are again displaced backwards relative to the floor rails 50, the following processes take place: Shortly before reaching the previously set position of the longitudinal adjustment mechanism, the so-called memory position, the actuating lug 106 of the slider 9 contacts the lug 96 of the latching member 4. The slider 9 now no longer takes part in the further movement of the seat rail 52 relative to the floor rail 50. Thus, it no longer moves relative to the carriage 1. The mounting member 7 continues to move together with the seat rail 52. After the contact between the actuating lug 106 and the lug 96, the seat rail 52 can still be displaced by about 6 to 8 mm backwards together with the mounting member 7. The biased comfort Bowden cable 21 is pulled by the corresponding amount. It is biased by the first spring 79. A pivoting movement of the retaining cam 78 in a downward direction takes place. Thus, the retaining cam 78 is freed from the stop member 74. The seat rest 62 is released. It can be folded upwards again. At the end of the backward displacement of the seat in the rails 50, 52, the contour C 114 abuts the latching member 4 and stops the seat via the latching tooth 94 engaged in the memory strip 17. The further backward displacement is thus blocked.

Once the seat rest 62 is back in the normal position (see FIG. 1), the unlocking Bowden cable 20 is relaxed. The ratchet teeth 82 can now engage again. The triggering lever 3 is moved via the spring 11; its flank A 100 thus comes behind the flank B 112 of the latching member 4. The latching member 4 is pivoted thereby; the latching tooth 94 is freed from the memory strip 17.

A particular advantage of the arrangement according to the invention lies in the fact that it can be combined into a single structural unit, see FIG. 4, which can be installed into the channel-shaped cavity of the rails 50, 52 as a prefabricated unit. A particular advantage also lies in the horizontal movement of the latching member 4. Further, a particular advantage lies in the fact that the exact memory position is located again, and this under all circumstances. It does happen in the prior art that it is not the exact memory position, but a position slightly forward or slightly backward thereof that is located again.

FIG. 4 shows the pre-assembled structural unit installed on the seat rail 52. The driver lever 15 is connected to the cross bar 86. In another embodiment, this connection is already realized and the driver lever 15 does not belong to the structural unit. The memory strip 17 and the carriage 1 do not belong to the structural unit. The memory strip 17 is connected to the floor rail 50; it is preferably directly formed by the latter. The carriage 1 is located on the memory strip 17 when the latter is installed. In an alternative, it is pushed on to the memory strip 17 in the longitudinal direction. It is also possible to add the memory strip 17 and the carriage 1 to the structural unit; in this case, the memory strip 17 is connected to the floor rail 50 later.

The parts triggering lever 3, slider 9 and mounting member 7 form a structural unit which is installed in the above-mentioned channel-shaped cavity. Specifically, it is connected to the seat rail 52.

A flank D 122 of the triggering lever 3 adjoining the flank A 100 is curved and formed in such a way that during the backward displacement, the triggering lever 3 is pushed upwards against the action of the main spring 11 and is able to slip over the entire carriage 1. Thus, the flank A 100 of the triggering lever 3 can be brought back again behind the flank B 112 of the latching member 4, whereby the carriage 1 is again coupled to the pin guide 30.

In the case of the comfort Bowden cable 21, only the core is working. The length of the elongated hole of the unlocking Bowden cable 20 is selected in such a way that in the case of a normal angular adjustment of the seat rest 62, no tension is exerted on the core of the comfort Bowden cable 21 in the position of use. In other words, the pin 81 does not come into contact with the ends of the elongated hole in the case of a normal angular adjustment of the seat rest 62.

The improved embodiment of the first example will be described in the following with reference to the FIGS. 5 to 10.

If, starting from the position according to FIG. 2, the memory position is reached again during the adjustment of the seat, the slider 9 pulls the comfort Bowden cable 21; the seat rest 62 is thus released. Then, the seat rest 62 can be moved into an upright position again. The distance on the slider 9 corresponds 1:1 to the distance on the comfort Bowden cable 21. However, this has a certain drawback. If the seat is pushed back with a small speed, a perceptible increase of the displacing force of the seat becomes noticeable. From the point in time at which the sequence of functions for releasing the seat rest begins, the user notices a clear increase in the displacing force.

In order to have the increase of the displacing force become less noticeable for the user, the principle of the loose roller was introduced in a first improvement. A transmission ratio of 1:2 was thus obtained. The displacing force in the sequence of functions for releasing the seat rest was thus halved. Specifically, the following is changed as compared with the first exemplary embodiment: The lower end of the core of the comfort Bowden cable 21 is now no longer connected directly to the slider 9; rather, a transmission means is interposed. It has a cable tab 150 and a comfort roller 152. The comfort roller 152 is freely rotatable in the cable tab 150. Moreover, the transmission means comprises a short cable 154 that loops around the comfort roller over about 180°. The core of the comfort Bowden cable 21 acts on the cable tab 150; it is hooked in there. The short cable 154 acts on the slider 9 with a first end. The other end of the short cable 154 is connected to the seat rail 52. The axis of rotation of the comfort roller 152 extends parallel to the y direction.

The main spring 11 causes a torque on the triggering lever 3, which is rotatably mounted. This torque acts as a contact force on the latching member 4 and presses it out of the latching engagement with the memory strip 17. In this case, the contact force has to be greater than the forces that act on the latching member 4 via the slider 9. By installing the loose contact roller 152, the force of the main spring 11, or the torque exerted by it on the triggering lever 3, is halved. Moreover, the main spring 11 is now located in the channel-shaped cavity delimited by the rails 50, 52. This results in a smaller construction space and to a more protected arrangement of the main spring 11.

In the first exemplary embodiment described above, the unlocking Bowden cable 20 unlocks the lock of the longitudinal adjustment mechanism of the rails when the seat rest 62 is folded forward; at the same time, the triggering lever 3 is pivoted forward; thus, the latching member 4 comes into engagement with the memory strip 17. This dual function is possible because, on the one hand, the end of the core of the unlocking Bowden cable 20 acts on the driver lever 15, which enables the unlocking of the longitudinal adjustment mechanism of the rails, and, on the other hand, the jacket of the unlocking Bowden cable is disposed on the triggering lever 3, whereby a pivoting movement of the triggering lever 3 is enabled.

However, this structure is disadvantageous in that the driver lever 15 has to have a relatively large lever length. Thus, an increased demand for constructional space becomes necessary. The jacket of the unlocking Bowden cable 20 disposed on the triggering lever 3 also requires construction space. In order to be able to reduce the construction space and make the triggering lever 3 smaller, the principle of a loose roller was introduced also in this case. In the second improvement, an unlocking roller 156 is provided which is rotatably mounted on a bolt 158. In that case, the driver lever 15 can be omitted. The jacket of the unlocking Bowden cable 20 is attached to the seat rail 52; this is done by means of a suitable retaining plate. The core of the unlocking Bowden cable 20 is routed around the unlocking roller 156; the end of the core is connected to the triggering lever 3 via a retaining plate. After the insertion of the memory system into the channel-shaped cavity of the rails 50, 52, the retaining plate is screwed to the triggering lever 3 via a threaded bushing. The bolt 158 is non-rotatably connected to the cross bar 86. The axis of rotation of the unlocking roller 156 extends parallel to the y direction.

A third improvement relates to the subsequent installation of the memory strip 17. According to the first embodiment, the memory strip 17 and the floor rail 50 are connected prior to the assembly of the rails 50, 52 into a pair of rails. In order to be able to equip only those longitudinal guides with a memory strip 17 that have a memory device, the memory strip 17 in the third improvement is subsequently inserted into a pair of rails and connected to the floor rail 50 after the rails 50, 52 were painted, joined to form a pair of rails, and a run-in process was carried out.

In the process, the memory strip 17 is connected to the floor rail 50 without damaging the already painted pair of rails by welding or the like.

The memory strip 17 comprises two hooks 170 which are configured to be substantially L-shaped. They protrude transversely from the actual memory strip 17 and stand in the same direction. They are closer to the ends of the memory strip 17 than to the center of the memory strip. They both point in the same direction, such as the positive x direction. Each of the hooks has an inclined clamping surface 176. It is a slight inclination on the surface thereof facing towards the body of the memory strip 17, such as a 2° inclination. A clamping action is thus obtained. The floor rail 50 comprises hook openings 172 adapted to the hooks 170. They are dimensioned in such a way that the hooks 170 can be plugged through the hook openings 172 in the y direction during the assembly.

The assembly proceeds as follows:

The memory strip 17 is introduced into the channel-shaped cavity in the longitudinal direction of the rails 50, 52 from the rear or the front. The memory strip 17 is positioned in such a way that the hooks 170 are aligned with the hook openings 172. Now, the hooks 170 are plugged through the hook openings 172. Then, the memory strip 17 is moved in the longitudinal direction of the rails 50, 52 in such a way that the hooks 170 slide along the outer surface of the floor rail 50 until the edge of the hook opening 172 has engaged the hook 170. A certain amount of force is required for this assembly step. An increasing clamping action is obtained due to the inclined clamping surfaces 176. A small deformation 174 is applied to the floor rail 50 at the rear end of the memory strip 17, seen in the direction of movement, and outside the range of movement of the carriage 1; the memory strip 17 thus fixed mechanically.

As FIG. 9 shows, the memory strip 17 has a bevel 178 at the end that is situated at the rear during the introduction into the channel-shaped cavity. It serves for fixing the memory strip 17 in the x direction. In the mounted state of the memory strip 17, the bevel 178 is in the immediate vicinity of, preferably in contact with, the deformation 174.

The applicant reserves the right to file and prosecute a separate application for the subsequently mountable memory strip 17. For example, this may be done by means of a divisional application. The third improvement is independent from the other improvements, and also independent from most of the features of claim 1, in any case from the features of the characterizing portion of claim 1.

1. A vehicle seat, comprising:
a base frame comprising at least one floor rail and a seat rail guided therein;
a lock for a longitudinal adjustment of the floor and seat rails relative to each other, the lock comprising:
at least one ratchet tooth; and
a latching strip with latching openings disposed one behind the other in the longitudinal direction of the rails, which is connected to the floor rail;
a memory device, comprising:
a memory strip comprising teeth that are disposed one behind the other in a periodic interval the longitudinal direction of the floor and seat rails;
a triggering lever disposed so as to be pivotable on the seat rail and having a flank;
a slider guided so as to be displaceable in the longitudinal direction of the rails on a guide member connected to the seat rail; and
a carriage comprising a housing which is guided on the memory strip in the longitudinal direction of the floor and seat rails and in which a latching member comprising a latching tooth cooperating with the teeth of the memory strip is pivotably mounted;
a seat support which is connected to the base frame and on which a retaining cam is pivotably mounted;
a seat rest connected to the seat support so as to be pivotable about a pivoting axis, the seat rest comprising:
trigger by which the folding of the seat rest forward about the pivoting axis can be triggered;
a stop cooperating with the retaining cam and retaining he seat rest in a forwardly folded position; and
a pin;
an unlocking Bowden cable whose core is connected at an upper end to the pin and at a lower end to the unlocking flap and whose jacket is disposed at an upper end on the seat support; and
a comfort Bowden cable whose core is connected at an upper end to the retaining cam and at a lower end to the slider and whose jacket is connected at an upper end to the seat support and at a lower end to the seat rail,
wherein the periodic interval of the memory strip is equal to the distance of two immediately adjacent latching positions of the ratchet tooth and the latching strip;
wherein at least one of the following features is satisfied additionally:
the components memory strip and carriage are located in a channel-shaped cavity delimited by the rails,
the components triggering lever, slider and mounting member form a structural unit which can be preassembled and which is installed in the seat rail,
the teeth of the memory strip extend in an x-y-plane,
the retaining cam is biased by a first spring in the latching direction with the stop, whereby the core of the comfort Bowden cable is elastically biased,
the jacket of the unlocking Bowden cable extends over a first path in the normal state, and a second path in the actuated state of this unlocking Bowden cable, the two paths are different, the clear distance between the two ends of the jacket differs by at least 4 mm,
the lower end of the jacket of the unlocking Bowden cable is disposed on the triggering lever, and
the latching member executes a locking movement in the x-y-plane.

2. The vehicle seat according to claim 1, wherein the slider comprises an actuating arm that protrudes through a hole in the seat rail.

3. The vehicle seat according to claim 1, wherein the slider comprises an actuating lug, the latching member comprises a lug, and the actuating lug and the lug come into contact with each other.

4. The vehicle seat according to claim 1, wherein a mounting member is provided which is fixed on the seat rail and forms an accommodating space in which the triggering lever is accommodated.

5. The vehicle seat according to claim 1, wherein the slider comprises a window, the guide member reaches into this window and the window has, in the longitudinal direction of the rails, an oversize of at least four millimeters over the length size of the guide member.

6. The vehicle seat according to claim 1, including a mounting member on which the triggering lever is pivotably mounted and on which the guide member is provided.

7. The vehicle seat according to claim 1, including several ratchet teeth which are elastically biased in a latching direction independently from each other and which can be jointly lifted into a releasing position via a unlocking flap.

8. The vehicle seat according to claim 7, wherein the several ratchet teeth are disposed at a periodic interval, the latching openings are disposed at a periodic interval, and the periodic interval of the memory strip is equal to the difference of the periodic interval of the latching openings and the periodic interval of the ratchet teeth.

9. The vehicle seat according to claim 1, including a pin guide for the ratchet teeth, which is connected to the seat rail.

10. The vehicle seat according to claim 1, including a main spring which acts on the triggering lever and elastically biases that into a final position, wherein the main spring is disposed in the channel-shaped cavity delimited by the floor rail and the seat rail.

11. The vehicle seat according to claim 1, wherein a cable tab, a comfort roller mounted rotatably therein and a short cable are disposed between the lower end of the core of the comfort Bowden cable and the slider, wherein the core acts on the cable tab, the short cable grips around the comfort roller and an end of the short cable acts on the slider, the other end being attached to the seat rail.

12. The vehicle seat according to claim 1, wherein an unlocking roller rotatably mounted on a bolt connected to a cross bar is provided between the lower end of the core of the unlocking Bowden cable and the unlocking flap, and that the lower end of the core is routed around the unlocking flap and fixed to the seat rail.

13. The vehicle seat according to claim 1, wherein the memory strip comprises hooks, and that the floor rail comprises hook openings adapted to these hooks.

14. A method for attaching a memory strip to a floor rail of a vehicle seat
with a base frame comprising at least the floor rail and a seat rail guided therein,
a lock for a longitudinal adjustment of these rails relative to each other, the lock comprising
at least one ratchet tooth and
a latching strip with latching openings disposed one behind the other in the longitudinal direction of the rails, which is connected to the floor rail,
with a memory device,
comprising the memory strip comprising teeth that are disposed one behind the other in a periodic interval in the longitudinal direction of the rails,
the method comprising:
inserting the memory strip, after the assembly of the floor rail and the seat rail, in the longitudinal direction of these rails into the channel-shaped cavity delimited by the floor rail and the seat rail,
wherein the memory strip comprises hooks, the floor rail comprises hook openings adapted to these hooks, and the hooks are hooked into the hook openings.
